(19) United States
(12) Patent Application Publication
(10) Pub. No.: US 2003/0142785 A1
(43) Pub. Date: Jul. 31, 2003

(54) X-ray-reflective mirrors exhibiting reduced thermal stress, and X-ray optical systems comprising same

(75) Inventor: Motofusa Kageyama, Yokohama-shi (JP)

Correspondence Address: KLARQUIST SPARKMAN, LLP, One World Trade Center, Suite1600, 121 S.W. Salmon Street, Portland, OR, 97204-2988, US

(73) Assignee: Nikon Corporation

(21) Appl. No.: 10/353,467

(22) Filed: Jan. 28, 2003

(30) Foreign Application Priority Data
Jan. 28, 2002 (JP) 2002-018205

(51) Int. Cl. G01N 23/20

(52) U.S. Cl. 378/70

(57) ABSTRACT

X-ray-reflective mirrors are disclosed, each including a thermal-transfer device that conducts heat (caused by absorption by the mirror of incident X-ray radiation) away from the mirror without imparting stress to the mirror. As a result, each such mirror exhibits, compared to conventional X-ray-reflective mirrors, reduced deformation and greater thermal stability during use of the mirror. A typical X-ray-reflective mirror is formed from a mirror substrate and has an “effective region” on which X-rays are incident. At least the effective region includes an X-ray-reflective coating (e.g., multilayer coating). Attached to the mirror are thermal-transfer members that function to conduct heat away from the mirror. Each thermal-transfer member is attached to a respective location outside the effective region of the mirror so as not to obstruct reflection of X-rays incident to the effective region. Distal ends of the thermal-transfer members are connected to a suitable cooling mechanism. The thermal-transfer members are configured and dimensioned so as not to impart any significant stress to the mirror.

### FIELD

This disclosure pertains to mirrors as used in X-ray reflective-optical systems, and to X-ray reflective-optical systems incorporating such mirrors. Such mirrors and optical systems are used, for example, in X-ray microlithography systems as used for manufacturing microelectronic devices such as semiconductor integrated circuits and display devices.

### BACKGROUND

Microlithography is a key technology used in the manufacture of microelectronic devices such as semiconductor integrated circuits and displays. Recent years have witnessed the progressive miniaturization of active circuit elements in microelectronic devices. In fact, this miniaturization has progressed to such an extent that conventional “optical” microlithography techniques (i.e., microlithography performed using ultraviolet, or “UV”, light) are increasingly incapable, due to diffraction limitations, of resolving individual active circuit elements used in such devices. As a result, substantial research and development effort currently is underway to develop a practical “next generation lithography” (NGL) technology capable of producing significantly finer pattern-element resolution than obtainable using optical microlithography, without a prohibitive reduction in throughput. The most promising avenue for achieving finer pattern-element resolution is utilization of a microlithography energy beam having a substantially shorter wavelength than the UV beam used for optical microlithography.

In view of the above, a key NGL technology is projection lithography performed using an X-ray beam. In this regard, “X-ray” encompasses, in addition to the conventional X-ray wavelength range, the so-called “soft X-ray” (SXR) wavelengths, also termed “extreme ultraviolet” (EUV) wavelengths. A typical X-ray projection-exposure (microlithography) system comprises an X-ray source, an illumination-optical system for the X-ray beam produced by the source, a reticle stage for holding a pattern- defining reticle, a projection-optical (image-formation) optical system, and a substrate stage for holding the lithographic substrate (e.g., semiconductor wafer).

Considering an EUV microlithography system by way of example, a typical EUV source is a synchrotron-radiation source or a laser-plasma source. The illumination-optical system typically comprises one or more grazing-incidence reflective mirrors, one or more multilayer-coated reflective mirrors, and one or more filters that reflect or transmit X-ray radiation only of a prescribed wavelength. The illumination-optical system is situated and configured to illuminate a selected region of the reticle with an X-ray beam of a desired wavelength.

The reticle typically is a reflective reticle rather than a transmissive reticle as used in optical microlithography. A transmissive reticle defines pattern elements as corresponding regions in a layer of X-ray-absorptive material formed on a thin, supporting layer of an X-ray-transmissive material. Unfortunately, it is extremely difficult to manufacture X-ray-transmissive reticles having practical dimensions and to manufacture X-ray optical systems capable of exposing an entire reticle pattern without excessive aberrations. An X-ray-reflective reticle defines pattern elements as corresponding regions of a low-reflective layer formed on an X-ray-reflective multilayer coating.

In any event, an image of the pattern defined by the reticle is transferred to the lithographic substrate by the projection-optical system. So as to be imprintable with the projected image, the substrate is coated with a material (termed a “resist”) that chemically responds to the exposure. The projection-optical system typically comprises a plurality of multilayer-coated reflective mirrors. Since X-ray radiation is absorbed and attenuated by the atmosphere, the optical path from the X-ray source to the substrate is maintained at a suitable high vacuum.

In the illumination-optical and projection-optical systems, optical elements such as lenses and conventional reflective mirrors as used in optical microlithography cannot be used because no known substances exist that refract X-ray wavelengths. Also, the reflectivity of conventional substances to incident X-ray radiation typically is extremely low. For these reasons, optical systems for X-rays generally comprise grazing-incidence reflective mirrors (i.e., mirrors that reflect, using total reflection, X-rays incident at an extremely high incidence angle to the reflective surface) and/or multilayer-coated reflective mirrors (i.e., mirrors that reflect X-rays incident at low angles of incidence by aligning the phases of X-rays reflected at respective interfaces of a multilayer coating formed on a polished surface of the mirror). Thus, multilayer-coated mirrors achieve high reflectance by an interference effect.

Grazing-incidence optical systems cannot achieve diffraction-limited resolving power over a wide range due to the large aberrations typically generated by grazing-incidence reflection. In contrast, multilayer-coated reflective mirrors are able to reflect a normally incident X-ray beam with extremely low aberrations and thus are capable of exhibiting diffraction-limited imaging using an X-ray beam. Consequently, in EUV lithography systems for example, at least the projection-optical system (image-formation optical system) typically comprises only multilayer-coated reflective mirrors.

The composition of the layers in a multilayer-coated mirror depends upon the particular wavelength with which the mirror is used. For example, for use with EUV wavelengths of 13 to 15 nm (representing the “long-wavelength” side of the L-absorption end, 12.3 nm, of silicon) the highest reflectance (approximately 70%, regardless of incidence angle) of EUV radiation from the mirror is obtained whenever the multilayer coating consists of alternating thin layers of molybdenum and silicon. On the short-wavelength side of the L-absorption end of silicon, there has been practically no development of multilayer coatings exhibiting a reflection of 30 percent or more of normally incident EUV radiation. The multilayer coating is formed on a mirror substrate that typically is a glassy material (e.g., quartz, or Zerodur® made by Schott) that can be polished to high precision with low surface roughness.

Since the maximum achievable reflectivity of incident X-rays from a multilayer-coated mirror is not 100%, the non-reflected incident X-rays are absorbed by the mirror. This absorption results in heating of the mirror. Hence, whenever a high-power X-ray beam is incident to such a mirror, the mirror can be heated sufficiently to exhibit deformation of its reflective surface. This surface deformation causes a corresponding degradation of the imaging performance of the mirror. In view of the extremely high level of imaging performance demanded of X-ray optical systems used for microlithography, degradation of imaging performance normally cannot be tolerated. One conventional manner of solving this problem is to reduce the exposure dose sufficiently to bring thermal deformation of the mirrors to within an acceptable specification. Unfortunately, this results in an unsatisfactorily low throughput. Another conventional manner of solving this problem is described in Japan Kôkai Patent Document No. Sho 63-312638, in which the multilayer-coated mirrors are provided with individual cooling conduits extending through the rear side of the respective mirror substrates. A suitable cooling fluid is circulated through the conduits.

Multilayer-coated mirrors as described above conventionally are mounted using individual plate springs or the like so as to avoid application of mounting stress to the mirrors. Despite such precautions, a mirror provided with cooling conduits conventionally has cooling conduits connected to the mirror for circulation of a coolant fluid to the mirror. These cooling conduits inevitably apply stress to the mirror. Also, after mounting the mirrors in a “column,” final adjustments of the mirrors relative to the column performed during calibration of the subject optical system impart stresses to the mirrors. As a result, the multilayer-coated mirrors making up an X-ray optical system usually exhibit warp that is sufficiently excessive to deteriorate optical performance of the system.

In view of the above, especially with respect to high-precision X-ray optical systems as used in, e.g., projection-exposure microlithography systems in which the effects of deformation of individual X-ray reflective mirrors are especially great, there is a need for greater reduction of thermal deformation of individual mirrors so as to achieve improved imaging performance.

### SUMMARY

In view of the shortcomings of conventional systems as summarized above, the present invention provides, inter alia, X-ray reflective mirrors comprising one or more thermal-transfer members that impart reduced stress to the mirrors.

According to a first aspect of the invention, X-ray-reflective mirrors are provided for use in an X-ray optical system. An embodiment of such a mirror comprises a mirror substrate defining a polished surface, and X-ray-reflective coating formed on the polished surface (at least on an effective region of the polished surface), and at least one thermal-transfer member attached to the mirror outside the effective region. The thermal-transfer member is attached so as not to obstruct X-ray radiation incident to or reflecting from the effective region, has low rigidity (as defined herein), and forms a heat-conduction pathway away from the mirror.

So as to have low rigidity, the thermal-transfer member can have a tape-like or longitudinally extended configuration. If the mirror substrate is a glassy material, then the thermal-transfer member desirably is made of a metal that can be bonded to the mirror substrate by anodic welding, which provides a “direct” (as defined herein) attachment of the thermal-transfer member to the mirror. Exemplary suitable metals are copper and aluminum.

The X-ray-reflective mirror desirably comprises multiple first thermal-transfer members each having a respective first end attached to a respective location on the mirror outside the effective region and a respective second end connected to a cooling mechanism. Thus, heat is conducted from the mirror through the first thermal-transfer members to the cooling mechanism. In this configuration the first ends of the first thermal-transfer members are attached to the mirror by anodic welding. This X-ray-reflective mirror further can comprise a second thermaltransfer member connected between the second ends of the first thermal-transfer members and the cooling mechanism. Thus, heat is conducted from the mirror through the first thermal-transfer members and through the second thermal-transfer member to the cooling mechanism. The second thermal-transfer member can be configured so as to conduct a coolant, wherein the coolant is circulated from the cooling mechanism through the second thermal-transfer medium.

The X-ray-reflective coating can be a multilayer coating. For X-ray wavelengths in the EUV range (e.g., 11-15 nm), the multilayer coating desirably comprises alternating layers of a first material selected from the group consisting of Si, Be, and B₄C, and a second material selected from the group consisting of Mo, Ro, and Rh.

Each X-ray-reflective mirror can comprise multiple thermal-transfer members each having a respective first end attached to a respective location on the mirror outside the effective region and a respective second end connected to a cooling mechanism. In this configuration, most of the thermal-transfer members desirably are connected to the mirror just outside the effective region.

The thermal-transfer members desirably are attached to the mirror “directly” (as defined herein). In this configuration the direct connection can be achieved using a mechanical fastener or by placing a bonding agent over a point of contact of the thermal-transfer member with the mirror.

The X-ray-reflective mirror further can comprise a metal layer formed on the mirror outside the effective region. In this configuration the mirror can comprise multiple first thermal-transfer members each having a respective first end attached to a respective location on the metal layer and a respective second end connected to a cooling mechanism. Thus, heat is conducted from the metal layer through the first thermal-transfer members to the cooling mechanism. The mirror further can comprise a second thermal-transfer member connected between the second ends of the first thermal-transfer members and the cooling mechanism, as summarized above. The first ends of the first thermal-transfer members desirably are connected to the metal layer by respective weld bonds, such as a spot-solder connection.

The X-ray-reflective mirror further can comprise a cooling mechanism, wherein the thermal-transfer member has a first end attached to the mirror and a second end attached to the cooling mechanism such that heat is conducted from the mirror through the thermal-transfer member to the cooling mechanism.

According to another aspect of the invention, X-ray optical systems are provided. An embodiment of such a system comprises at least one X-ray-reflective mirror as summarized above. The X-ray optical system can be configured as, for example, a projection-optical system of an X-ray microlithography system.

According to yet another aspect of the system, X-ray microlithography systems are provided that employ an X-ray beam for transfer-exposing a pattern from a reticle to a substrate. An embodiment of such a system comprises at least one X-ray-reflective mirror as summarized above.

According to yet another aspect of the invention, methods are provided for fabricating a microelectronic device. An embodiment of such a method comprises a microlithography step performed using an X-ray microlithography system as summarized above.

The foregoing and additional features and advantages of the invention will be more readily apparent from the following detailed description, which proceeds with reference to the accompanying drawings.

### BRIEF DESCRIPTION OF THE DRAWINGS

FIGS. 1(a)-1(b) are a plan view and elevational view, respectively, of an X-ray-reflective mirror according to a first representative embodiment.

FIGS. 2(a)-2(b) are a plan view and elevational view, respectively, of an X-ray-reflective mirror according to a second representative embodiment.

FIGS. 3(a)-3(b) are an oblique view and orthogonal view, respectively, of a first thermal-transfer member configured as multiple parallel tape-like portions, as used in the second representative embodiment.

FIGS. 4(a)-4(b) are a plan view and elevational view, respectively, of an X-ray-reflective mirror according to a third representative embodiment.

FIG. 5 is a flowchart of an exemplary method for manufacturing a microelectronic device, wherein the method includes a microlithography step performed using an X-ray microlithography apparatus including a representative embodiment of an X-ray optical system.

FIG. 6 is a flowchart of an exemplary microlithography process in the method of FIG. 5.

FIG. 7 is a schematic optical diagram of a “reducing” projection-optical system as used in an X-ray projection-microlithography system.

### DETAILED DESCRIPTION

The invention is described below in the context of representative embodiments that are not intended to be limiting in any way.

Generally, X-ray reflective mirrors as used in a projection-optical system of an X-ray microlithography system are configured with (or nearly with) rotational symmetry about an optical axis, but with an “effective region” (region on which X-rays are incident and from which X-rays actually are reflected) that usually is off-axis and not rotationally symmetrical about the optical axis. The reflective surfaces of the mirrors can be spherical or aspherical as required. For example, FIG. 7 depicts an exemplary reducing projection-optical system for an X-ray projection-microlithography system. (“Reducing” means that the image as formed on the substrate is “reduced” or “demagnified” relative to the corresponding pattern as defined on the reticle.) The depicted projection-optical system comprises aspherical X-ray reflective mirrors 11, 12, 13. Each mirror 11, 12, 13 has a respective effective region 11a, 12a, 13a from which the X-ray beam actually is reflected. Portions of the mirrors 11, 12, 13 located outside the respective effective regions 11a, 12a, 13a are useful for mounting and cooling the mirrors, as described later below.

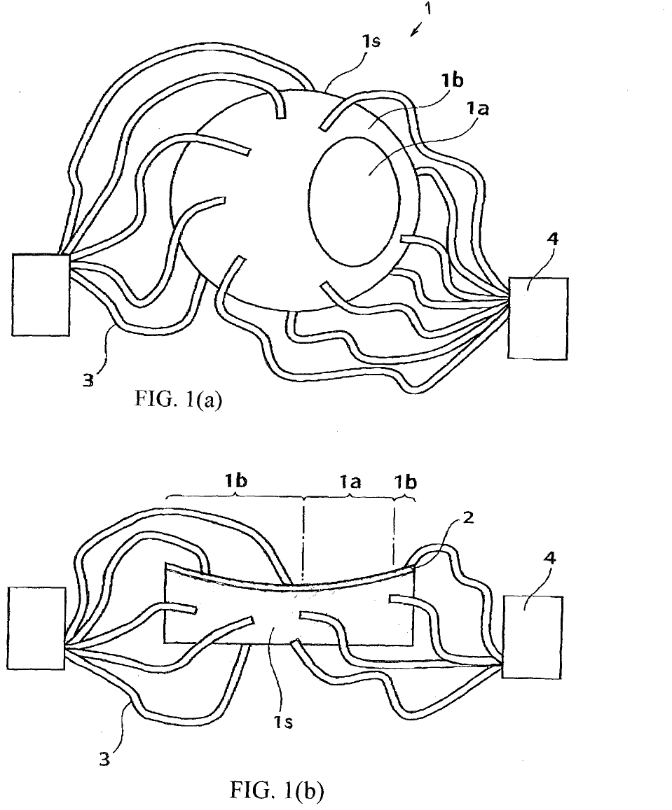

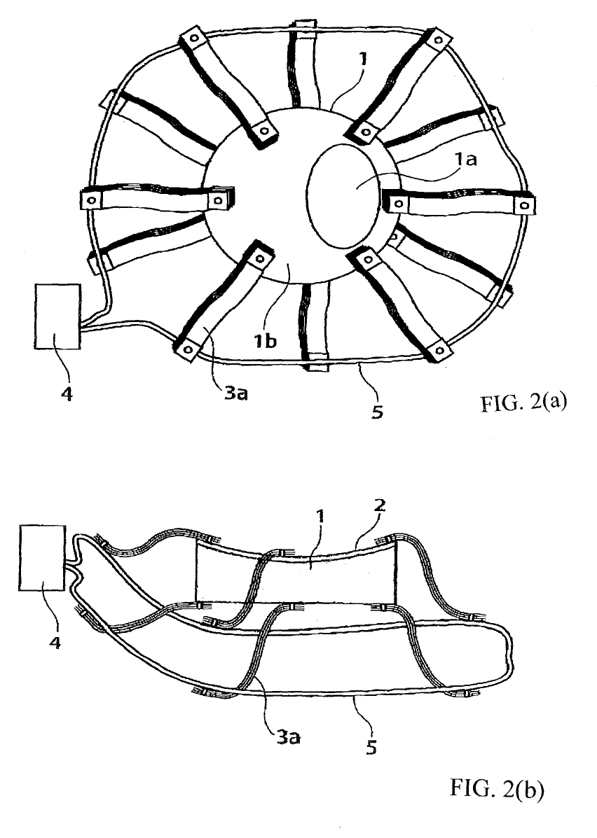

A first representative embodiment of an X-ray-reflective mirror 1 is depicted in FIGS. 1(a)-1(b). The subject mirror 1 comprises a mirror substrate Is defining a polished surface that has an X-ray-reflective coating 2 (e.g., multilayer coating). The reflective surface includes an effective region 1a. The depicted region 1b is located outside the effective region 1a. Attached to various locations on the mirror 1 outside the effective region 1 a are multiple thermal-transfer members 3 that serve as heat-conduction conduits for removing heat from the mirror 1. The mirror 1 can be mounted in a “column” (effectively a vacuum chambers) in a conventional manner (e.g., using a plate spring or the like, not shown) in a manner such that mechanical stress from the mounting is not conveyed to the mirror.

The depicted X-ray-reflective mirror can be used, for example, in a projection-optical system of a reducing X-ray projection-microlithography system that utilizes an EUV beam having a wavelength of 13 nm. The mirror substrate 1s can be quartz that defines a finely polished surface. For reflecting 13-nm EUV light, the X-ray-reflective coating 2 desirably is a Mo/Si multilayer coating. The X-ray-reflective coating 2 is not limited to a Mo/Si multilayer coating. For wavelengths in the range of 10-15 nm, the reflective coating 2 can be a multilayer coating of one or more of Si, Be, and B₄C and one or more of Mo, Ro, and Rh, depending upon the specific wavelength employed.

The thermal-transfer members 3 are attached individually to respective locations on the mirror I outside the effective region l a, and are directed away from their respective attachment locations so as not to obstruct the effective region 1a. The distal ends of the thermal-transfer members 3 are attached to a cooling mechanism 4. Thus, the thermal-transfer members 3 and cooling mechanism 4 collectively constitute a thermal “trap” or “sink” for the mirror 1. Each thermal-transfer member 3 is longitudinally extended and is constructed of a material that has high thermal conductivity and that is sufficiently flexible so as not to impart, collectively or individually, any significant stress to the mirror 1.

Most of the X-ray radiation incident to the effective region l a is reflected by the X-ray-reflective coating 2 in the effective region I a. Incident radiation that is not reflected is absorbed and converted into heat in the X-ray-reflective coating 2. This heat is transmitted through the X-ray-reflective coating 2 (which has high thermal conductivity) outward from the effective region 1a. Although this heat tends to disperse throughout the X-ray-reflective coating 2, it is desirable to attach most of the thermal-transfer members 3 in the region 1b relatively near the effective region 1a. Thermal-transfer members 3 also can be attached to respective locations outside the region 1b, such as on the edges and rear of the mirror substrate Is. The thermal-transfer members 3 are made sufficiently flexible by reducing their individual rigidity by physical or structural means. For example, as shown, each thermal-transfer member 3 has a high ratio of length to width. By making the thermal-transfer members 3 flexible in this manner, stress imparted to the mirror 1 by thermal deformation and/or positional or postural changes of the members 3 is minimized effectively. For effective cooling of the mirror 1, the thermal-transfer members 3 desirably are made of a high-thermal-conductivity material such as copper or aluminum. Both of these materials are relatively flexible, especially when configured as structures having a high ratio of length to width. Desirably, many thermal-transfer members 3 are attached to each mirror to ensure efficient and rapid cooling of the mirror 1. From the instant disclosure, it will be understood that the number of thermal-transfer members actually employed per mirror 1 can be selected based on various factors to achieve a rate of thermal conduction sufficient to maintain mirror performance to within specification.

Similarly, a thermal-transfer member having “low rigidity” means that the rigidity of the subject thermal-transfer member effectively prevents transfer of stress to and from the mirror so as to maintain mirror performance to within specification. In other words, with a low-rigidity thermal-transfer member, stress produced by mechanical deformation of the thermal-transfer member is not transmitted to the mirror in an amount that compromises the requisite operational precision and accuracy of the mirror. Exemplary materials capable of providing such low rigidity in wire or tape form, while maintaining sufficient thermal conductivity, include copper and aluminum. For these and other materials, it will be understood that the requisite low rigidity also can be achieved by configuring each thermal-transfer member with a low-rigidity structure. One exemplary low-rigidity structure is a wire or tape-like structure having a low transverse area relative to length. Another exemplary low-rigidity structure is an articulated or bellows structure.

Attachment of the thermal-transfer members 3 to the mirror 1 desirably is performed in a manner involving direct contact of the material of each member 3 to the mirror. This is in contrast to indirect attachment, which involves use of an intermediary substance such as an adhesive. Direct attachment achieves reduced thermal resistance between the mirror and the members 3. Direct attachment can be achieved by, for example, screws or analogous fasteners, or use of a bonding agent placed over (rather than between) points of contact of the members 3 with the mirror 1.

Mirror heat generated by incident X-ray radiation and conducted from the mirror 1 by the thermal-transfer members 3 is absorbed by the cooling mechanism 4. Thus, the thermal-transfer members 3 serve as thermal conduits from the mirror 1 to the cooling mechanism 4, without having to rely solely on the mirror 1 itself to conduct heat away from itself. The cooling mechanism 4 can be, for example, a heat-exchange device through which a coolant fluid is circulated. Exemplary coolant fluids include liquids such as water or oil or gases such as Freon®. Thus, it will be understood that the cooling mechanism 4 can be any of various types of cooling devices. A single cooling mechanism 4 can be connected in this manner to the respective thermal-transfer members 3 of multiple X-ray-reflective mirrors.

In general, the X-ray-reflective mirror 1 is housed within a vacuum chamber or other suitable housing (not shown) providing both the requisite “column” structure and a suitable vacuum environment for the mirror. Thus, the cooling mechanism 4 desirably is located outside the chamber. Since, with such a configuration, the thermal-transfer members 3 extend through the wall of the vacuum chamber, an appropriate feed-through seal is required.

A second representative embodiment of an X-ray-reflective mirror 1 is depicted in FIGS. 2(a)-2(b), in which components that are similar to corresponding components of the first representative embodiment have the same respective reference numerals. The second representative embodiment differs from the first representative embodiment in the following aspects: (1) thermal transfer from the mirror 1 to the cooling mechanism 4 is via first thermal-transfer members 3a connected to the mirror and second thermal-transfer members 5 connecting the first thermal-transfer members 3a to the cooling mechanism 4; and (2) use of anodic welding to attach ends of the first thermal-transfer members 3a to the mirror 1.

Each first thermal-transfer member 3a comprises multiple parallel, flexible, tape-like portions, as discussed below. One end of each first thermal-transfer member 3a is attached to a respective location on the mirror 1, and the other end is attached to the second thermal-transfer member 5. Each first thermal-transfer member 3a has a length sufficient to provide compliance between the mirror I and the second thermal-transfer member 5 in the event of changes in the gap between the mirror 1 and the second thermal-transfer member 5. Thus, in the event of a change in said gap, stress is not imparted to the mirror 1. Also, even if the second thermal-transfer member 5 has relatively high rigidity compared to the first thermal-transfer members 3a, stress (e.g., from the cooling mechanism 4) is not imparted to the mirror 1 while still allowing effective conduction of heat away from the mirror 1 via the thermal-transfer members 3a, 5.

The second thermal-transfer member 5 desirably is made of a material having high thermal conductivity. To further improve its thermal conduction, the second thermal-transfer member 5 may be hollow so as to allow cooling fluid from the cooling mechanism 4 to flow through the second thermal-transfer member 5. The distal ends of the first thermal-transfer members 3a can be attached to the second thermal-transfer member 5 by anodic welding or by use of mechanical fasteners such as screws or rivets made of, e.g., copper or aluminum.

By way of example, each tape-like portion of a first thermal-transfer member 3a is made of copper with a thickness of 0.05 mm and a width of 10 mm, and with 40 tape-like portions used in each first thermal-transfer member 3a. An exemplary thermal conductivity is 400 W/mK at 20° C. If the gap between the mirror 1 and the second thermal-transfer member 5 is 150 mm, for example, each first thermaltransfer member 3a desirably has a length of 300 mm. By reducing the thickness of each tape-like portion of the first thermal-transfer members 3a, the rigidity of each first thermal-transfer member 3a is greatly reduced. Also, by making their length sufficiently long with respect to the gap between the mirror 1 and the second thermal-transfer member, the first thermal-transfer members 3a apply substantially zero stress to the mirror 1, even if the gap changes.

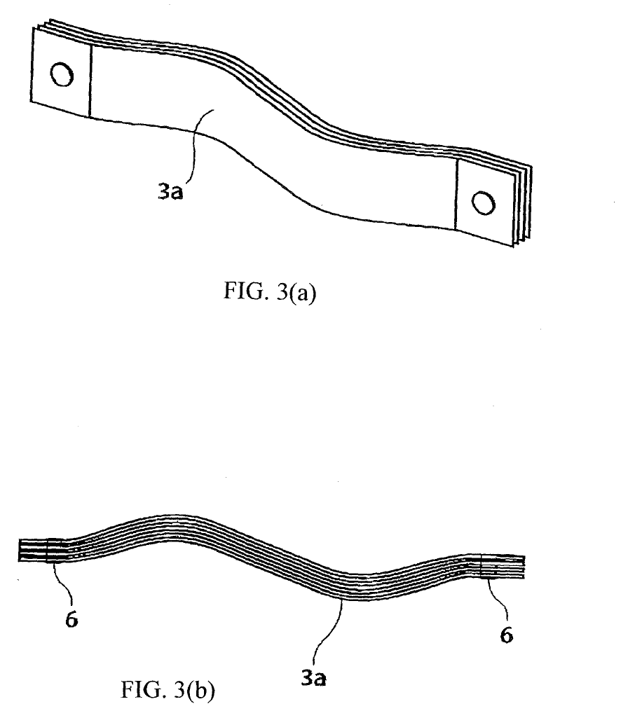

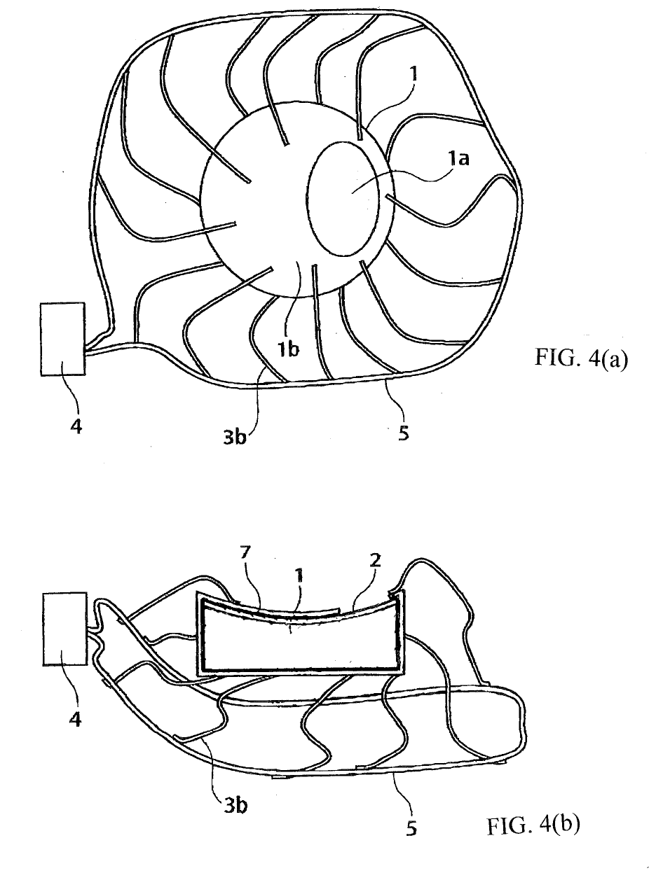

Note that the transverse area of each first thermal-transfer member 3a desirably is relatively small so as to provide the lowest practical rigidity of the member (see FIG. 3(a)) without substantially compromising its thermal conductivity. Also, each first thermal-transfer member 3a desirably is attached only at its respective ends 6 to the mirror 1 and second thermal-transfer member 5. By keeping the transverse area of each member 3a low relative to length, the collective high thermal-transfer efficacy of the members 3a can be retained by providing many members 3a between the mirror 1 and the second thermal-transfer member 5. In this regard, in one example embodiment, adequate performance is obtained using twenty first thermal-transfer members 3 a connected between the mirror 1 and the second thermal-transfer member 5. The first thermal-transfer members 3a need not be dimensioned identically. In any particular configuration, optimal performance of the first thermal-transfer members 3a can be obtained as appropriate by combining first thermal-transfer members 3a having transverse sections of different widths and thicknesses.

The first thermal-transfer members 3a are attached (at their respective ends 6) to the mirror 1 desirably by anodic welding. For example, the mirror 1 can be made from a glass mirror substrate, and the first thermal-transfer members 3a can be made of aluminum. The end 6 of a first thermal-transfer member 3a is welded anodically to the mirror 1 by applying local heat and voltage, as well as a crimping pressure, to the point of contact of the end 6 with the mirror 1. An anodic weld exhibits minimal thermal resistance because it lacks an interposed medium (e.g., bonding agent or adhesive) between the end 6 and the mirror 1. Also, an anodic weld is tenacious and produces substantially no outgassing, which is highly advantageous in a vacuum environment such as used in an X-ray projection-optical system.

If an anodic weld must be made to a location on a multilayer coating, either the multilayer coating at the location desirably is removed before making the weld or a material capable of being anodically welded is formed locally on the multilayer coating at the site of the weld.

A third representative embodiment of an X-ray-reflective mirror I is depicted in FIGS. 4(a)-4(b), in which components that are similar to corresponding components of the first and second representative embodiments have the same respective reference numerals. The third representative embodiment differs from the second representative embodiment in the following aspects: (1) thermal transfer from the mirror 1 is achieved using longitudinally extended first thermal-transfer members 3b; (2) for attachment of the first thermal-transfer members 3b to the mirror 1, a metal layer 7 is formed on the surface of the mirror in the region 1b (which is outside the effective region 1a of the mirror 1); and (3) respective ends of the first thermal-transfer members 3b are weld-bonded to respective locations on the metal layer 7.

By way of example, the mirror substrate, as in the other representative embodiments, is a glassy material. Each of the first thermal-transfer members 3b is a respective copper wire, and the metal layer 7 is a layer of copper that is vapor-deposited on the surface of the mirror outside the effective region 1 a. Weld-bonding of the ends of the first thermal-transfer members 3b to the metal layer 7 can be by spot-soldering using a solder having a low electrical resistance, such as used in connecting pin wires to respective pads on semiconductor integrated-circuit chips. Copper wire is advantageous for use in making the first thermal-transfer members 3b because such wire can have high flexibility without compromising thermal conductivity. Thus, the wires provide effective thermal-conduction paths from the mirror 1 without excessive stress being applied to the mirror. In addition, vapor deposition is an effective method for forming the metal layer 7 because vapor deposition results in formation of a uniform-thickness layer at all desired locations on the mirror, regardless of the shape of the mirror substrate 1.

It will be understood that any of various X-ray optical systems can be constructed that comprises one or more X-ray-reflective mirrors according to one or more of the representative embodiments described above. In addition, such an X-ray optical system can be incorporated readily into an X-ray microlithography system (see FIG. 7).

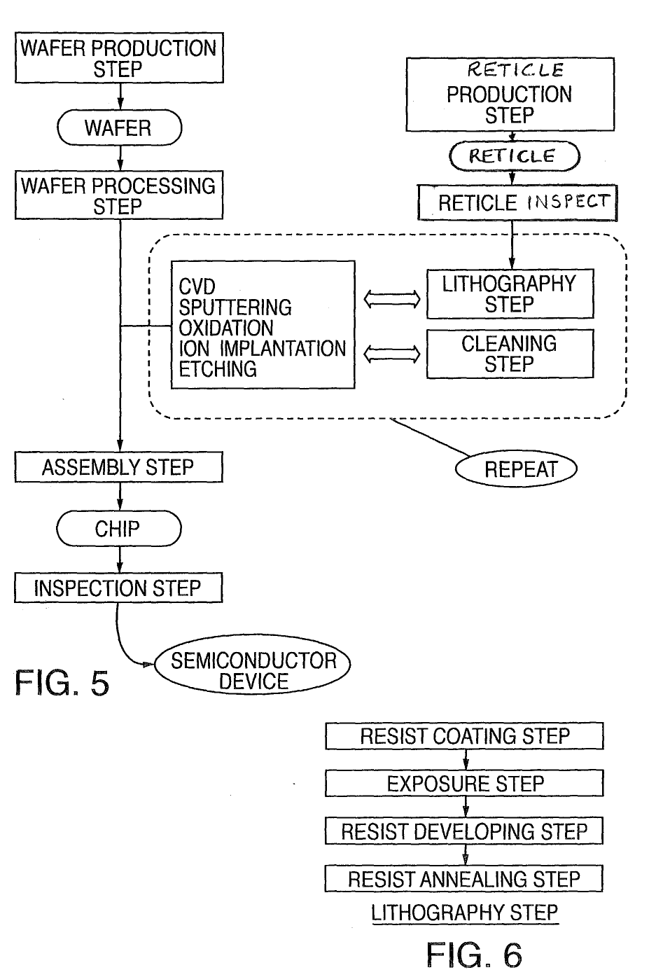

FIG. 5 is a flowchart of an exemplary microelectronic-device-fabrication method to which apparatus and methods as described herein can be applied. The fabrication method generally comprises the main steps of wafer production (wafer preparation) that results in preparation of a wafer on which the microelectronic devices are formed, reticle production (reticle preparation) that results in preparation of a pattern-defining reticle used in microlithographic exposure or other suitable method for transferring the pattern from the reticle to the wafer, wafer processing that results in fabrication of the microelectronic devices on the wafer, device assembly that results in production of one or more individual functional device “chips” cut from the wafer, and inspection of completed chips. Each of these steps usually comprises several sub-steps.

Among the main steps, wafer processing is key to achieving the smallest feature sizes (critical dimensions) and best inter-layer registration. In the wafer-processing step, multiple circuit patterns are layered successively atop one another on the wafer, wherein the formation of each layer typically involves multiple sub-steps. Usually, multiple operative microelectronic devices (“chips”) are produced on each wafer.

Typical wafer-processing steps include: (1) thin-film formation involving formation (e.g., by CVD or sputtering) of a dielectric layer for insulation or a metal layer for forming electrodes or for connecting wires, (2) an oxidation step that oxidizes the thin-film layer or the wafer substrate; (3) microlithography, using a reticle, that forms a resist pattern for selective processing of the thin film or the substrate itself, (4) etching or analogous step (e.g., dry-etching) to etch the thin film or substrate according to the resist pattern, (5) doping as required to implant and diffuse ions or impurities into the thin film or substrate according to the resist pattern, (6) resist-stripping to remove the resist from the wafer, and (7) wafer inspection to assess the results of steps (1)-(6). Wafer processing is repeated as required (typically many times to form the many layers normally required) to fabricate the desired microelectronic devices on the wafer.

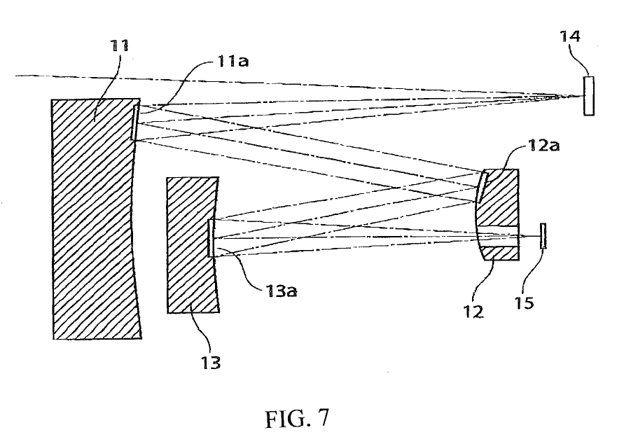

FIG. 6 provides a flowchart of typical steps performed in microlithography, which is a principal step in wafer processing. The microlithography step typically includes: (1) resist-coating step, in which a suitable resist is coated on the wafer substrate (which can include circuit elements formed in a previous wafer-processing step), (2) exposure step, to expose the resist with the desired pattern, (3) development step, to develop the exposed resist and obtain the desired pattern in the resist, and (4) optional annealing step, to stabilize and/or enhance the durability of the resist pattern as formed in the resist.

The exposure step involves microlithography performed using a microlithography system that includes an X-ray optical system comprising one or more X-ray-reflective mirrors as described above. Since the constituent X-ray-reflective mirrors exhibit reduced stress-related deformation (including thermal stress), enhanced microlithographic accuracy and precision is obtained using the system.

Whereas the invention has been described in connection with multiple representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. An X-ray-reflective mirror for use in an X-ray optical system, the mirror comprising:
a mirror substrate defining a polished surface;
an X-ray-reflective coating formed on the polished surface, at least on an effective region of the polished surface; and
at least one thermal-transfer member attached to the mirror outside the effective region so as not to obstruct X-rays incident to or reflecting from the effective region, the thermal-transfer member having low rigidity and forming a heat-conduction pathway away from the mirror.

2. The X-ray reflective mirror of claim 1, wherein the thermal-transfer member has a tape-like or longitudinally extended configuration.

3. The X-ray-reflective mirror of claim 2, wherein:
the mirror substrate is a glassy material; and
the thermal-transfer member is made of a metal.

4. The X-ray-reflective mirror of claim 3, wherein an end of the thermal-transfer member is bonded to the mirror substrate by anodic welding.

5. The X-ray-reflective mirror of claim 3, wherein the metal comprises at least one of copper and aluminum.

6. The X-ray-reflective mirror of claim 2, wherein the thermal-transfer member is made of a metal comprising at least one of copper and aluminum.

7. The X-ray-reflective mirror of claim I, comprising multiple first thermal-transfer members each having a respective first end attached to a respective location on the mirror outside the effective region and a respective second end connected to a cooling mechanism, such that heat is conducted from the mirror through the first thermal-transfer members to the cooling mechanism.

8. The X-ray-reflective mirror of claim 7, wherein the first ends are attached to the mirror by anodic welding.

9. The X-ray-reflective mirror of claim 7, further comprising a second thermal-transfer member connected between the second ends of the first thermal-transfer members and the cooling mechanism, such that heat is conducted from the mirror through the first thermal-transfer members and through the second thermal-transfer member to the cooling mechanism.

10. The X-ray-reflective mirror of claim 9, wherein the first ends of the first thermal-transfer members are connected to the mirror by anodic welding.

11. The X-ray-reflective mirror of claim 9, wherein the second thermaltransfer member is configured so as to conduct a coolant, wherein the coolant is circulated from the cooling mechanism through the second thermal-transfer member.

12. The X-ray-reflective mirror of claim 1, wherein the X-ray-reflective coating is a multilayer coating.

13. The X-ray-reflective mirror of claim 12, wherein the multilayer coating comprises alternating layers of a first material selected from the group consisting of Si, Be, and B₄C, and a second material selected from the group consisting of Mo, Ro, and Rh.

14. The X-ray-reflective mirror of claim 1, further comprising multiple thermal-transfer members each having a respective first end attached to a respective location on the mirror outside the effective region and a respective second end connected to a cooling mechanism, wherein most of the thermal-transfer members are connected to the mirror just outside the effective region.

15. The X-ray-reflective mirror of claim 1, wherein the thermal-transfer member is attached to the mirror directly.

16. The X-ray-reflective mirror of claim 15, wherein the direct connection is achieved using a mechanical fastener or by placing a bonding agent over a point of contact of the thermal-transfer member with the mirror.

17. The X-ray-reflective mirror of claim 1, further comprising a metal layer formed on the mirror outside the effective region.

18. The X-ray-reflective mirror of claim 17, comprising multiple first thermal-transfer members each having a respective first end attached to a respective location on the metal layer and a respective second end connected to a cooling mechanism, such that heat is conducted from the metal layer through the first thermal-transfer members to the cooling mechanism.

19. The X-ray-reflective mirror of claim 18, further comprising a second thermal-transfer member connected between the second ends of the first thermal-transfer members and the cooling mechanism, such that heat is conducted from the metal layer through the first thermal-transfer members and through the second thermal-transfer member to the cooling mechanism.

20. The X-ray-reflective mirror of claim 19, wherein the first ends of the first thermal-transfer members are connected to the metal layer by respective weld bonds.

21. The X-ray-reflective mirror of claim 20, wherein each weld bond is a spot-solder connection.

22. The X-ray-reflective mirror of claim 1, further comprising a cooling mechanism, wherein the thermal-transfer member has a first end attached to the mirror and a second end attached to the cooling mechanism such that heat is conducted from the mirror through the thermal-transfer member to the cooling mechanism.

23. The X-ray-reflective mirror of claim 1, wherein the thermal-transfer member is configured with multiple tape-like or longitudinally extended portions arranged in parallel and with ends thereof being bundled together at each end of the thermal-transfer member.

24. The X-ray-reflective mirror of claim 23, wherein multiple thermaltransfer members are attached to the mirror.

25. An X-ray optical system, comprising at least one X-ray-reflective mirror, the mirror comprising:
a mirror substrate defining a polished surface;
an X-ray-reflective coating formed on the polished surface, at least on an effective region of the polished surface; and
at least one thermal-transfer member attached to the mirror outside the effective region so as not to obstruct X-rays incident to or reflecting from the effective region, the heat-transfer body having low rigidity and forming a heat-conduction pathway away from the mirror.

26. The X-ray optical system of claim 25, configured as a projection-optical system of an X-ray microlithography system.

27. An X-ray microlithography system employing an X-ray beam for transfer-exposing a pattern from a reticle to a substrate, the system comprising at least one X-ray-reflective mirror, the mirror comprising:
a mirror substrate defining a polished surface;
an X-ray-reflective coating formed on the polished surface, at least on an effective region of the polished surface; and
at least one thermal-transfer member attached to the mirror outside the effective region so as not to obstruct X-rays incident to or reflecting from the effective region, the heat-transfer body having low rigidity and forming a heat-conduction pathway away from the mirror.

28. A method for fabricating a microelectronic device, comprising a microlithography step performed using an X-ray microlithography system as recited in claim 27.

29. A method for conducting heat, caused by absorption of incident X-ray radiation, away from an X-ray-reflective mirror having a reflective surface and an effective region of the reflective surface, the method comprising:
outside the effective region, attaching to the mirror at least one thermaltransfer member such that X-rays incident to or reflecting from the effective region are not obstructed by the thermal-transfer member, the thermal-transfer member being thermally conductive so as to form a heat-conduction pathway away from the mirror and having a rigidity sufficiently low so as to prevent transmission of mechanical stress to the mirror via the thermal-transfer member; and
via the thermal-transfer member, conducting heat away from the mirror without imparting mechanical stress to the mirror so as to prevent accumulation of heat and stress in the mirror that otherwise would deform the mirror sufficiently to cause the mirror to exhibit an optical performance outside of acceptable specifications.

30. The method of claim 29, wherein the conducting step comprises conducting the heat from the thermal-transfer member to a cooling mechanism.

31. The method of claim 29, wherein the step of attaching the thermaltransfer member comprises attaching multiple first thermal-transfer members to the mirror outside the effective region.

32. The method of claim 31, wherein the conducting step comprises conducting the heat from the first thermal-transfer members to a cooling mechanism to which the first thermal-transfer members are connected.

33. The method of claim 32, wherein the conducting step comprises conducting the heat from the first thermal-transfer members to a second thermaltransfer member to which the first thermal-transfer members are connected, and from the second thermal-transfer member to the cooling mechanism.

34. The method of claim 33, further comprising the step of circulating a coolant from the cooling mechanism through the second thermal-transfer member.

35. The method of claim 29, wherein:
the mirror comprises a mirror substrate formed of a glassy material; and
the step of attaching the thermal-transfer member comprises bonding an end of the thermal-transfer member to the mirror substrate by anodic welding.
